(19) United States
(12) Patent Application Publication
(10) Pub. No.: US 2024/0102925 A1
(43) Pub. Date: Mar. 28, 2024

(54) Electronic Computer, Moisture Content Measurement Method, and Moisture Content Measurement System

(71) Applicant: Hitachi, Ltd., Chiyoda-ku, Tokyo (JP)

(72) Inventors: Yasuko KOBAYASHI, Tokyo (JP); Jun TANAKA, Tokyo (JP); Takuya KAMBAYASHI, Tokyo (JP); Yusuke KAGA, Tokyo (JP); Shunsuke KONO, Tokyo (JP); Kotaro KITAMURA, Tokyo (JP); Makiko UDAGAWA, Tokyo (JP); Hiroki MIYAKAWA, Tokyo (JP)

(21) Appl. No.: 18/274,583

(22) PCT Filed: Nov. 30, 2021
(86) PCT No.: PCT/JP2021/043971

§ 371 Date: Jul. 27, 2023

(30) Foreign Application Priority Data
Mar. 3, 2021 (JP) 2021-033976

(51) Int. Cl. G01N 21/3554; C02F 1/00; C02F 11/12

(52) U.S. Cl. CPC G01N 21/3554; C02F 1/008; C02F 11/12; C02F 2209/006; G01N 2201/12753

(57) ABSTRACT

A moisture content measurement method that calculates moisture content of dehydrated sludge using a calibration curve for calculating the moisture content of the dehydrated sludge, the calibration curve being obtained by performing multivariate regression analysis after first-order differential processing or an offset correction is performed on absorbance for reflected light or reflectance for infrared rays from dehydrated sludge, the absorbance or the reflectance being obtained by measuring the dehydrated sludge using an infrared measurement apparatus provided with a light-receiving unit that can receive at least infrared rays reflected from a target object to be measured and a light source that has a plurality of infrared LEDs that can emit infrared rays having respectively different wavelengths or a light source having an infrared-region tungsten lamp or halogen lamp.

### TECHNICAL FIELD

The present invention pertains to measurement of moisture content of dehydrated sludge generated by a sludge treatment facility in a sewage treatment plant.

### BACKGROUND ART

In sewage treatment at a sewage treatment plant, solid content and moisture in sewage sludge are separated by techniques such as screening and gravitational settling, and sewage sludge collected as solid content is subject to dehydration treatment using a technique such as squeezing and collected as dehydrated sludge.

The collected dehydrated sludge, as industrial waste from the sewage treatment plant, is handed over to a contractor and incinerated or used to create reclaimed land, for example.

However, there is an enormous amount of dehydrated sludge generated from a sewage treatment plant, the cost of disposing of sludge is a burden for, inter alia, a local government, or a maintenance contractor, and improving the efficiency of sludge treatment is desired.

From among sewage treatment steps, steps having many problems for improving the efficiency of sludge treatment include a sludge dehydration step which is the final step in sewage treatment and separates moisture and solid matter by squeezing sludge, and an agglomeration step which is before the sludge dehydration step and addresses reducing moisture content of dehydrated sludge by adding a flocculant to cause suspended matter in sewage to agglomerate and thereby form floc which is aggregated particles. However, consideration can be given to a case where, due to the aging of skilled workers at sewage treatment plants and labor shortages accompanying declining birth rates, there will be insufficient transfer of techniques, and it will not be possible to appropriately carry out sewage treatment steps.

Accordingly, as an example of addressing improving the efficiency of sludge treatment, consideration can be given to making one solution be digitalization that presents a worker with an optimal operation on the basis of a result of monitoring a sewage treatment status in real time and a result based on a past operation for a sewage treatment facility.

In order to carry out digitalization at the sewage treatment plant described above, monitoring the sewage treatment status in real time becomes necessary, but moisture content of dehydrated sludge for the sludge dehydration step is typically measured off-line by sampling the dehydrated sludge. Furthermore, such measurement is performed by a method that performs heating and drying and calculates from the dry weight and, as an example, requires approximately two hours to obtain the moisture content of dehydrated sludge. Accordingly, the situation is that it difficult to perform feedback in real time using digital information and assist work on-site.

By contrast, Patent Document 1 discloses a technique that uses infrared spectroscopy to measure the moisture content of dehydrated sludge in real time. In detail, Patent Document 1 discloses an infrared moisture measurement apparatus provided with a plurality of filters (six types of interference filters), a light source, and an optical system. Here, from among infrared rays of narrow bands having dominant wavelengths at 1940 nm, 1300 nm, 1725 nm, 1800 nm, 2060 nm, and 2100 nm, respectively, the plurality of filters each selectively transmit infrared rays which are selected according to types of dehydrated sludge to be measured. The light source radiates light including infrared rays onto the filters. The optical system irradiates the dehydrated sludge with infrared rays obtained via the filters, and also receives reflected light that is infrared rays from the dehydrated sludge. The technique from Patent Document 1 selects a combination of wavelengths, according to the types of dehydrated sludge to be measured, and calculates a moisture value on the basis of one calibration curve that correspond to infrared rays having a selected wavelength and of the amount of light reflected by the dehydrated sludge for these infrared rays.

### PRIOR ART DOCUMENT

### Patent Document

Patent Document 1: JP-2003-156437-A

### SUMMARY OF THE INVENTION

### Problem to be Solved by the Invention

However, with the technique in Patent Document 1, because a plurality of interference filters is used, a measurement apparatus becomes complex and large, and there are cases where an on-site installation location is limited.

Accordingly, an objective of the present invention is to provide a moisture content measurement method that can measure moisture content of dehydrated sludge by a small and simple measurement device, an electronic computer that can execute this moisture content measurement method, and a moisture content measurement system that can execute this moisture content measurement method.

### Means for Solving the Problem

By virtue of a first aspect of the present invention, the following electronic computer is provided. The electronic computer can calculate a moisture content of dehydrated sludge discharged from a sludge dehydrator belonging to a sewage treatment plant. The electronic computer is provided with a processor and a storage resource. A moisture content calculation program is disposed in the storage resource. The processor executes the moisture content calculation program, and calculates moisture content of dehydrated sludge using a calibration curve for calculating the moisture content of the dehydrated sludge, the calibration curve being obtained by performing multivariate regression analysis after differential processing or offset correction on absorbance for reflected light or reflectance for infrared rays from dehydrated sludge, the absorbance or the reflectance being obtained by measuring the dehydrated sludge using an infrared measurement apparatus provided with a light-receiving unit that can receive at least infrared rays reflected from a target object to be measured and a light source that has a plurality of infrared LEDs that can emit infrared rays having respectively different wavelengths or a light source having a lamp that can continuously emit infrared rays.

By virtue of a second aspect of the present invention, the following moisture content measurement method is provided. The moisture content measurement method is a method of calculating moisture content of dehydrated sludge by using an electronic computer. The moisture content measurement method calculates the moisture content of dehydrated sludge by using a calibration curve for calculating the moisture content of the dehydrated sludge, the calibration curve being obtained by performing multivariate regression analysis after differential processing or offset correction processing is performed on absorbance for reflected light or reflectance for infrared rays from dehydrated sludge, the absorbance or the reflectance being obtained by measuring the dehydrated sludge using an infrared measurement apparatus provided with a light-receiving unit that can receive at least infrared rays reflected from a target object to be measured and a light source that has a plurality of infrared LEDs that can emit infrared rays having respectively different wavelengths or a light source having a lamp that can continuously emit infrared rays.

By virtue of a third aspect of the present invention, the following moisture content measurement system is provided. The moisture content measurement system is provided with a processor, a storage resource, a sludge dehydrator, and an infrared measurement apparatus. The sludge dehydrator is installed at a sewage treatment plant, and dehydrates sludge to thereby discharge dehydrated sludge. The infrared measurement apparatus is provided with a light-receiving unit that can receive at least infrared rays reflected from a target object to be measured and a light source that has a plurality of infrared LEDs that can emit infrared rays having respectively different wavelengths or a light source having a lamp that can continuously emit infrared rays. A moisture content calculation program is disposed in the storage resource. The processor executes the moisture content calculation program and calculates moisture content of dehydrated sludge using a calibration curve for calculating the moisture content of the dehydrated sludge, the calibration curve being obtained by performing multivariate regression analysis after differential processing or offset correction processing is performed on absorbance for reflected light or reflectance for infrared rays from dehydrated sludge, the absorbance or the reflectance being obtained by measuring the dehydrated sludge using the infrared measurement apparatus.

By virtue of a fourth aspect of the present invention, the following electronic computer is provided. The electronic computer can calculate a moisture content of dehydrated sludge discharged from a sludge dehydrator belonging to a sewage treatment plant. The electronic computer is provided with a processor and a storage resource. A moisture content calculation program is disposed in the storage resource. The processor executes the moisture content calculation program to calculate moisture content of dehydrated sludge using a calibration curve for calculating the moisture content of the dehydrated sludge, the calibration curve being obtained by performing multivariate regression analysis after, by offset correction processing or the like, reducing noise in an absorption spectrum for reflected light that is infrared rays from the dehydrated sludge, the absorption spectrum being obtained by measuring the dehydrated sludge using an infrared measurement apparatus provided with a tungsten or halogen white-light source that emits infrared rays, a mechanism that can diffract reflected light into respectively different wavelengths, and a light-receiving unit that can receive infrared rays reflected from a target object to be measured.

By virtue of a fifth aspect of the present invention, the following moisture content measurement method is provided. The moisture content measurement method calculates moisture content of dehydrated sludge using an electronic computer. The moisture content measurement method calculates moisture content of dehydrated sludge using a calibration curve for calculating the moisture content of the dehydrated sludge, the calibration curve being obtained by performing multivariate regression analysis after, by offset correction processing or the like, reducing noise in an absorption spectrum for reflected light that is infrared rays from the dehydrated sludge and in some cases after also performing differential processing, the absorption spectrum being obtained by measuring the dehydrated sludge using an infrared measurement apparatus provided with a white-light source such as a halogen or tungsten lamp that can emit infrared rays and a light-receiving unit that, after infrared rays reflected from a target object to be measured are diffracted into respective wavelengths, can receive infrared light having the respective wavelengths.

By virtue of a sixth aspect of the present invention, the following moisture content measurement system is provided. The moisture content measurement system is provided with a processor, a storage resource, a sludge dehydrator, and an infrared measurement apparatus. The sludge dehydrator is installed at a sewage treatment plant, and dehydrates sludge to thereby discharge dehydrated sludge. The infrared measurement apparatus is provided with: a light-emitting unit that has a light source (a white-light source such as a tungsten lamp or a halogen lamp) and can emit infrared rays through a fiber; and a light-receiving unit that can diffract infrared rays reflected from a target object to be measured and receive reflected infrared light having respective wavelengths. A moisture content calculation program is disposed in the storage resource. The processor executes the moisture content calculation program and calculates moisture content of dehydrated sludge using a calibration curve for calculating the moisture content of the dehydrated sludge, the calibration curve being obtained by performing multivariate regression analysis after noise reduction processing by offset correction or the like is performed on an absorption spectrum for reflected light that is infrared rays from dehydrated sludge, the absorption spectrum being obtained by measuring the dehydrated sludge using the infrared measurement apparatus.

### Advantages of the Invention

By virtue of the present invention, a moisture content measurement method that can measure moisture content of dehydrated sludge by a small and simple measurement device, an electronic computer that can execute this moisture content measurement method, and a moisture content measurement system that can execute this moisture content measurement method are provided.

### BRIEF DESCRIPTION OF THE DRAWINGS

FIG. 1 is a view for describing an example of a configuration of a moisture content measurement system, according to a first embodiment.

FIG. 2 is a view for describing an example of a configuration of a moisture content measurement system, according to the first embodiment.

FIG. 3 is a view for describing an example of a configuration of a moisture content measurement system, according to the first embodiment.

FIG. 4 is a flow chart for describing an example of a method for calculating moisture content of dehydrated sludge by obtaining a calibration curve, according to the first embodiment.

FIG. 5 is a flow chart for describing an example of a method for calculating moisture content of dehydrated sludge by obtaining a calibration curve, according to the first embodiment.

FIG. 6 is a flow chart for describing an example of processing by a sewage sludge treatment facility operation assistance navigation system, according to a second embodiment.

FIG. 7 is a flow chart for describing an example of processing by a sewage sludge treatment facility operation assistance navigation system, according to a third embodiment.

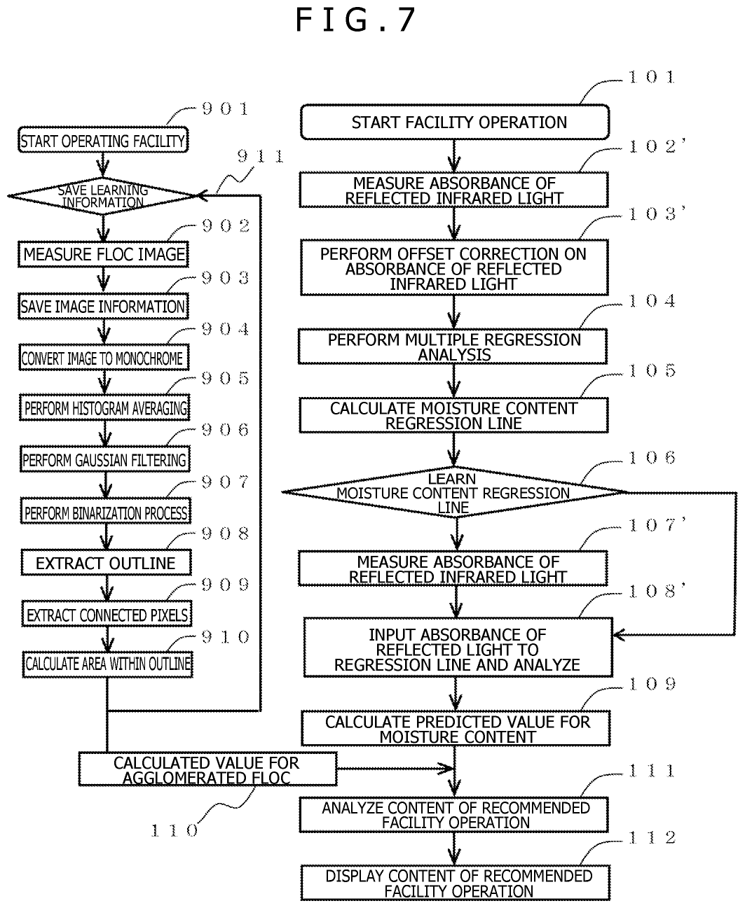

### MODES FOR CARRYING OUT THE INVENTION

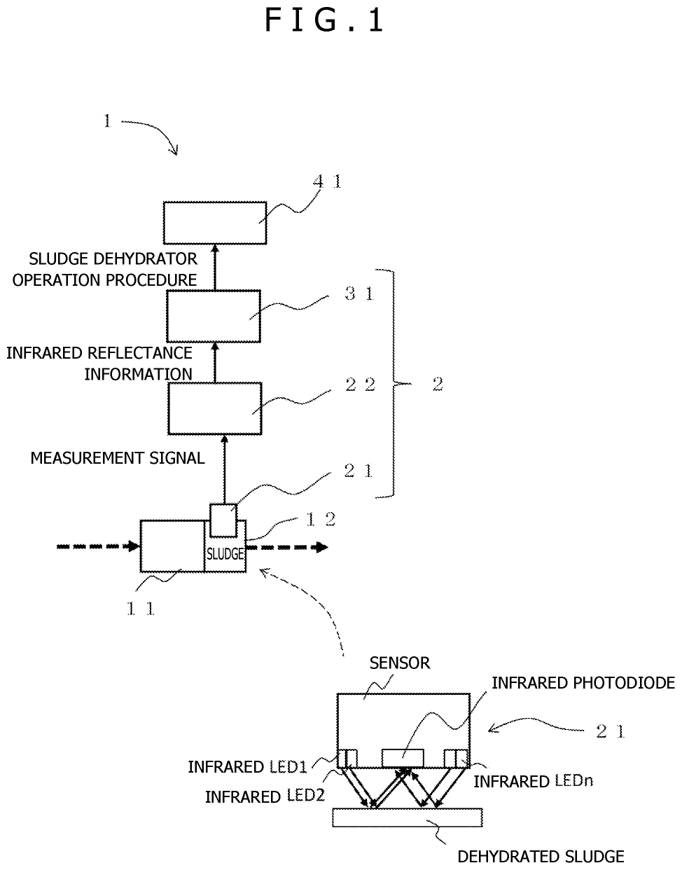

Using the drawings, description is given below regarding embodiments of the present invention in order to solve the problem set forth in the technical problem. FIG. 1 through FIG. 3 are views for describing examples of configurations of a moisture content measurement system, according to the first embodiment.

A moisture content measurement system 1 illustrated in FIG. 1 can measure dehydrated sludge in a sewage treatment plant to thereby calculate moisture content, and is provided with a sludge dehydrator and a moisture content measurement mechanism 2.

The sludge dehydrator is provided with a sludge dehydrator dehydration unit 11 and a sludge dehydrator discharge unit 12. The sludge dehydrator dehydration unit 11 configures a dehydration unit for the sludge dehydrator, and performs dehydration treatment on sludge which flows in from an upstream side. As an example, the sludge dehydrator dehydration unit 11 can be a belt press dehydrator, a screw press dehydrator, or a centrifugal dehydrator. The sludge dehydrator discharge unit 12 configures a discharge unit for the sludge dehydrator, and sludge subjected to the dehydration treatment by the sludge dehydrator dehydration unit 11 is discharged outside of the sludge dehydrator via the sludge dehydrator discharge unit 12 and supplied to a downstream side.

The moisture content measurement mechanism 2 is provided with an infrared measurement apparatus 21, an infrared signal processing apparatus 22, and a computer 31 (electronic computer).

The infrared measurement apparatus 21 converts light (infrared rays) in an infrared region received after being reflected from a target object into an electrical signal (may be referred to as a measurement signal). The infrared measurement apparatus 21 is appropriately provided such that it is possible to measure dehydrated sludge after the dehydration treatment by the sludge dehydrator dehydration unit 11. The infrared measurement apparatus 21 is, for example, provided in the sludge dehydrator discharge unit 12, on a flow path on the downstream side of the sludge dehydrator discharge unit 12, etc. In a case of providing a sludge storage tank on the downstream side of the sludge dehydrator discharge unit 12 in a sewage treatment plant, the infrared measurement apparatus 21 may be provided at a sludge discharge port of a sludge transfer pump or in the sludge storage tank. In a case where the surface of the dehydrated sludge is uneven, the light-reception signal information will vary. Therefore, a scraper or a pressing mechanism may be provided as a mechanism for flattening the surface of the dehydrated sludge.

As illustrated in FIG. 1, the infrared measurement apparatus 21 is configured by an infrared sensor in which a light source and a light-receiving unit are integrally provided. It is possible for the light source to be configured by a plurality of infrared LEDs (Light-Emitting Diodes), and for respective infrared LEDs to emit infrared rays of respectively different wavelengths. The light-receiving unit is configured by an infrared photodiode. The light-receiving unit receives reflected light or scattered light from a target object (dehydrated sludge in the present embodiment) to thereby generate a current.

The infrared signal processing apparatus 22 performs signal processing on an inputted measurement signal, and obtains infrared reflectance information (an infrared spectrum), and the obtained infrared reflectance information is outputted to the computer 31. This infrared reflectance information is analyzed, as a result of which the moisture content of the dehydrated sludge is obtained.

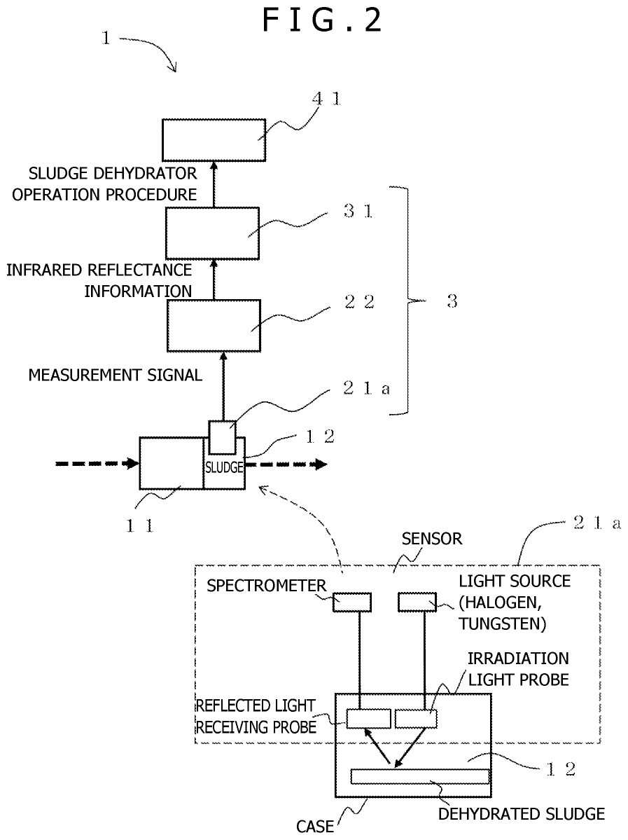

In addition, as illustrated in FIG. 2, an infrared measurement apparatus may have a configuration (infrared measurement apparatus 21a) in which the infrared sensor is separately provided with a light source and a light-receiving unit. In this case, a moisture content measurement mechanism 3 is configured. In this configuration, the light source is configured using a white-light source such as tungsten lamp or a halogen lamp. This light source can continuously emit infrared rays having wavelengths in an infrared region, and can irradiate a target object with infrared rays having respective wavelengths all at once. The light-receiving unit is provided with a spectrometer, and receives reflected light or scattered light from the target object (dehydrated sludge in the present embodiment) after the reflected light or scattered light is separated into infrared rays having the respective wavelengths. Note that, in the case where the angle between an irradiation optical fiber and a reflected-light receiving fiber (in other words, the angle formed by the directions of an irradiation light probe and a reflected light receiving probe) is 45 degrees, received light intensity is good, but this angle is set, as appropriate, such that the received light intensity becomes larger.

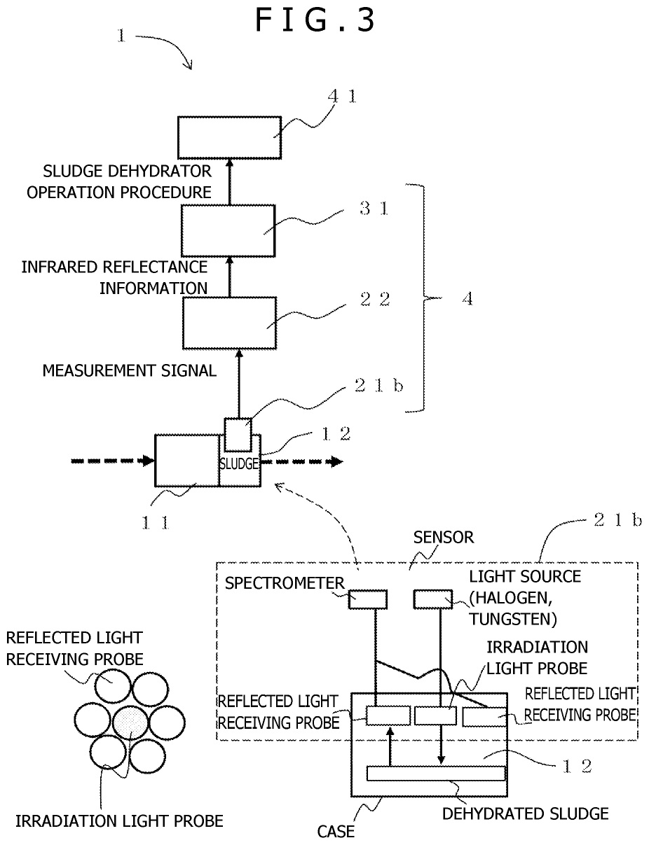

In addition, as illustrated in FIG. 3, an infrared measurement apparatus may have a configuration (infrared measurement apparatus 21b) in which, centered on an irradiation optical fiber (irradiation light probe), reflected-light receiving fibers (reflected light receiving probes) surround the perimeter of the irradiation optical fiber. In this case, a moisture content measurement mechanism 4 is configured. In this configuration, the irradiation optical fiber and the reflected-light receiving fibers are installed so as to be parallel when viewed from a side surface. It is desirable for the irradiation optical fiber and the reflected-light receiving fibers to be installed such that reflected light is received parallel or approximately parallel (a narrow angle) to the irradiation light.

The infrared measurement apparatus (21a, 21b) converts light (infrared rays) in an infrared region received after reflecting from a target object into an electrical signal (may be referred to as a measurement signal). The infrared measurement apparatus (21a, 21b) is appropriately provided such that it is possible to measure dehydrated sludge after the dehydration treatment by the sludge dehydrator dehydration unit 11. The infrared measurement apparatus (21a, 21b) is, for example, provided in the sludge dehydrator discharge unit 12, on a flow path on the downstream side of the sludge dehydrator discharge unit 12, etc. In a case of providing a sludge storage tank on the downstream side of the sludge dehydrator discharge unit 12 in a sewage treatment plant, a sludge discharge port of a sludge transfer pump or the infrared measurement apparatus (21a, 21b) may be provided in the sludge storage tank.

The infrared signal processing apparatus 22 performs signal processing on a measurement signal inputted from the infrared measurement apparatus (21a, 21b), obtains infrared reflectance information or infrared absorbance information (an infrared spectrum), and the obtained infrared reflectance information or infrared absorbance information is outputted to the computer 31. This infrared reflectance information or infrared absorbance information is analyzed, as a result of which the moisture content of the dehydrated sludge is obtained.

The electronic computer 31 is provided with a processor and a storage resource. The processor is configured as an arithmetic apparatus. For the storage resource, it is possible to employ an appropriate recording apparatus (for example, a hard disk drive). In the present embodiment, the storage resource stores a program (a moisture content calculation program) used to calculate moisture content of dehydrated sludge discharged from a sludge dehydrator at a sewage treatment plant using a calibration curve, the calibration curve being obtained in order to calculate the moisture content of the dehydrated sludge in accordance with performing multivariate regression analysis (multiple regression analysis in the present embodiment) after differential processing (first-order differential processing in the present embodiment) has been performed on the reflectance of infrared rays reflected from the dehydrated sludge. The program stored in the storage resource is executed by the processor. Note that, in a case of a measurement apparatus that employs a lamp such as a tungsten lamp as a light source, what is stored is a program (moisture content calculation program) used to calculate moisture content of dehydrated sludge using a calibration curve, the calibration curve being obtained in order to calculate the moisture content of the dehydrated sludge in accordance with performing multivariate regression analysis (multiple regression analysis in the present embodiment) after reducing noise of an infrared absorption spectrum by performing, inter alia, offset correction processing for an absorption spectrum, and after performing differential processing (first-order differential processing) in some cases. Here, the offset correction processing, as an example, aligns the absorbance of the spectrum for a specific wavelength to 0 for all absorbance data for a wavelength range to be analyzed.

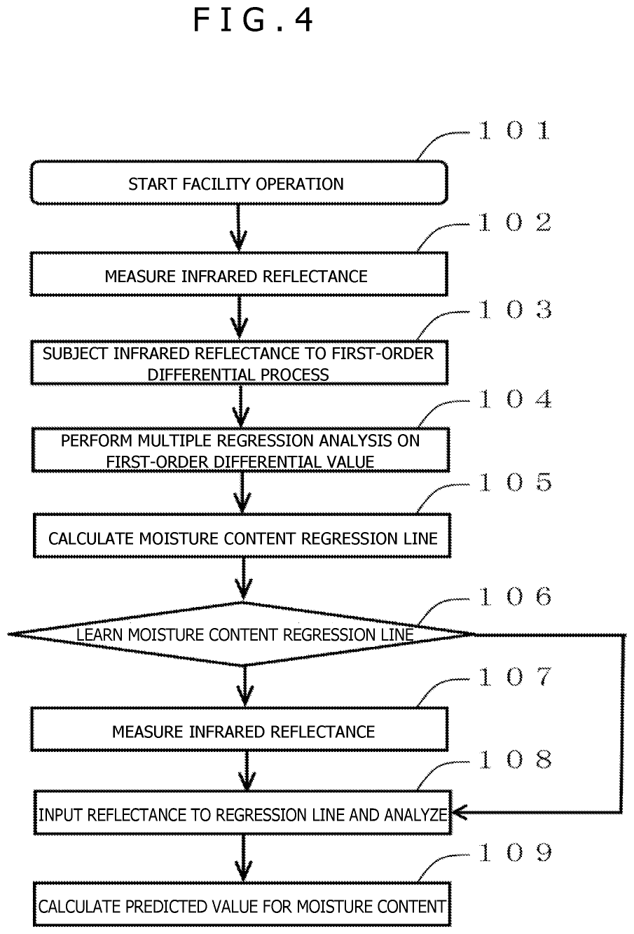

Next, description is given regarding an example of calculating moisture content of dehydrated sludge using the moisture content measurement system 1. FIG. 4 is a flow chart for describing an example of a method for calculating moisture content of dehydrated sludge by obtaining a calibration curve.

After the moisture content measurement system 1 starts operating (S101), processing for obtaining a calibration curve for calculating moisture content of dehydrated sludge is performed (S102 through S106). In processing step S102, an infrared measurement apparatus is used to irradiate dehydrated sludge having a known moisture content with infrared rays, and infrared reflectance information for the known dehydrated sludge is inputted to the computer 31 via the infrared signal processing apparatus 22. Note that it is sufficient if the computer 31 can obtain the infrared reflectance information, and operation of the infrared measurement apparatus may be controlled by the computer 31, as an example. In this case, the storage resource in the computer 31 stores a program for causing the infrared measurement apparatus to operate appropriately, and the processor executes the program as a result of which the infrared measurement apparatus operates appropriately.

In processing step S102, in detail, measurement is performed for dehydrated sludges having respectively different moisture content. In the case of an LED light source, the dehydrated sludge is irradiated with infrared light having a plurality of wavelengths in the wavelength range of greater than or equal to 1300 nm and less than or equal to 2400 nm, and the quantity of reflected infrared rays is measured over time. In the case of, inter alia, a light source that is a lamp such as a tungsten lamp, the dehydrated sludge is irradiated with infrared light, and the quantity of infrared rays is measured over time after reflected infrared rays are diffracted in a wavelength range of greater than or equal to 1100 nm and less than or equal to 2600 nm. By this measurement over time, the computer 31 obtains infrared reflectance information for each of the dehydrated sludges which have different moisture content. Because infrared light is absorbed by a water component, the reflectance decreases the higher the moisture content of dehydrated sludge and increases the lower the moisture content of dehydrated sludge.

The computer 31 performs first-order differential processing on the infrared reflectance, and obtains a value that is based on the first-order differential processing (S103). In other words, the computer 31 obtains data indicating correspondence between first-order differential value (dimensionless) of the infrared reflectances pertaining to the dehydrated sludges having respectively different moisture content, and the wavelengths.

The computer 31 performs multiple regression analysis on a result of the first-order differential processing (S104), as a result of which a regression line (calibration curve) is obtained (S105). In other words, in processing steps S104 and S105, a calibration curve: Y=b₁X₁+b₂X₂+ . . . +bₙXₙ+b₀ (b₀, b₁, . . . bₙ=coefficients) is obtained. Here, it is sufficient if an appropriate calibration curve can be obtained. In the multiple regression analysis, the number of variables (in other words, the interval between data points in the wavelength range) can be appropriately defined, and the coefficients (b₀, b₁, . . . , bₙ) are obtained by the multiple regression analysis. The wavelength range is not particularly limited, but, as an example, the calibration curve is obtained on the basis of data for a wavelength range having little variation for first-order differential values for dehydrated sludges having respectively different moisture content.

The computer 31 can calculate the moisture content (a prediction value) of dehydrated sludge on the basis of a result of inputting wavelength data corresponding to X (in detail, wavelength data corresponding to X obtained from the infrared reflectance) to the calibration curve. Note that, as described above, upon considering the absorption of infrared rays by water, it is possible to perform measurement in the wavelength range of greater than or equal to 1100 nm and less than or equal to 2600 nm, obtain a calibration curve by taking first derivatives of the obtained reflectance for the infrared rays, and thereby accurately calculate the moisture content of dehydrated sludge using the calibration curve.

The computer 31 causes the storage resource to store, as learning information, the calibration curve obtained in processing step S105 (S106). In subsequent processing, the computer 31 calculates the moisture content using the calibration curve that the storage resource has been caused to store as learning information (S107 through S109).

For example, dehydrated sludge discharged over time from a sludge dehydrator is measured over time by an infrared measurement apparatus (S107), and the computer 31 obtains infrared reflectance information based on data obtained by the measurement over time. In processing step S107, as an example, the dehydrated sludge is measured over time by the infrared measurement apparatus 21 irradiating with infrared rays having a plurality of wavelengths in the wavelength range of greater than or equal to 1300 nm and less than or equal to 2400 nm. On the basis of an analysis result obtained by inputting the infrared reflectance (in detail, wavelength data that corresponds to X in the calibration curve and is obtained from the infrared reflectance) obtained by the measurement to the calibration curve (S108), the computer 31 calculates moisture content of the dehydrated sludge (S109).

Note that, in the present embodiment, moisture content of dehydrated sludge (in other words the dehydrated sludge for which the moisture content is known and which has been measured in S102 described above) used to obtain the calibration curve is in a range of greater than or equal to 60 wt % and less than 90 wt %. On the basis of this condition, it is possible to obtain a calibration curve having good accuracy. In addition, moisture content of dehydrated sludge (in other words, the dehydrated sludge discharged from the sludge dehydrator and measured in S107 described above) calculated using the calibration curve is in the range of greater than or equal to 60 wt % and less than 85 wt %. On the basis of this condition, it is possible to accurately calculate moisture content of dehydrated sludge.

The dehydrated sludge moisture content measurement method described in the present embodiment is capable of performing a simple measurement. In addition, a simple measurement mechanism can be used to perform measurement. In other words, it is possible to perform measurement using a small and simple infrared measurement apparatus instead of a measurement apparatus that uses, inter alia, an interference filter. Accordingly, it is possible to handle the problem of a measurement apparatus becoming complex whereby the measurement apparatus becomes large, and an installation location on-site being limited. Furthermore, by virtue of the dehydrated sludge moisture content measurement method described in the present embodiment, for example, it is possible to increase measurement accuracy by subjecting the infrared reflectance to first-order differential processing as analysis preprocessing. Accordingly, it is possible to calculate dehydrated sludge moisture content at high accuracy.

Note that, in processing for analyzing dehydrated sludge moisture content measured using an infrared measurement apparatus, it is possible to accurately obtain the moisture content of the dehydrated sludge by performing first-order differential processing, and a reason therefor is considered to be that an effect due to differences in sensitivity for each wavelength of infrared rays received or differences in ability to irradiate with respective infrared rays is suppressed by the first-order differential processing, as an example. In other words, for example, in a case where the intensity of infrared rays irradiated is stronger for shorter wavelengths than longer wavelengths and the sensitivity for received infrared rays is higher for shorter wavelengths than longer wavelengths, it is considered that measurement results on a longer wavelength side may be buried by measurement results on a shorter wavelength side, but it is considered that this is resolved by differential processing.

In the present embodiment, description is given regarding first-order differential processing as differential processing, but first-order differential processing is an example, the differential processing to be performed, for example, may be selected as appropriate according to components of the dehydrated sludge, and the differential processing is not limited to first-order differential processing. In addition, it may be that, before multiple regression analysis, offset processing is performed on the reflection spectrum, to reduce noise in the infrared reflectance spectrum. In addition, smoothing or the like may be employed in order to reduce noise in the infrared reflectance spectrum, and selection is appropriately performed such that the accuracy of predicting the moisture content is increased.

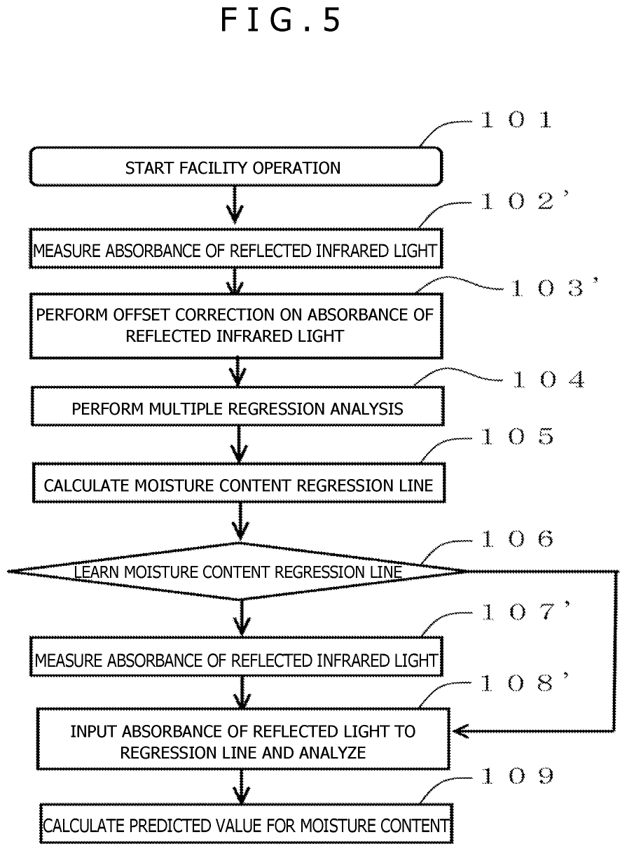

In addition, in a case of using a white-light source such as a tungsten lamp or a halogen lamp, as illustrated in FIG. 5, it may be that the absorbance of the reflected infrared light is measured (S102′), the spectrum of the absorbance of the reflected infrared light is subject to offset correction (S103′), and the calibration curve is obtained. It may be that analysis is performed by inputting the absorbance obtained by the measurement to this calibration curve (S108′), and a prediction value for moisture content is calculated.

As illustrated in FIG. 1 through FIG. 3, the moisture content measurement system 1 may be provided with a display apparatus 41. Here, the display apparatus 41 can be configured as an appropriate display, and can be disposed within the sewage treatment plant. The display apparatus 41 may be caused to display the calculated dehydrated sludge moisture content (in other words, the moisture content calculated in S109 described above). In this case, as an example, a program that is appropriate for causing display of the dehydrated sludge moisture content is stored in the storage resource in the computer 31, and the dehydrated sludge moisture content is displayed on the basis of the processor executing the program.

Incidentally, consideration can be given to a case where, due to the aging of skilled workers at sewage treatment plants and labor shortages accompanying declining birth rates, there will be insufficient transfer of techniques, and it will not be possible to appropriately carry out sewage treatment steps. With respect to this problem, one solution can be digitalization that presents a worker with details of an optimal operation that is based on a result of monitoring a sewage treatment status in real time and a result based on a past operation for a sewage treatment facility.

To give a description in detail, the abovementioned problem is resolved by comparing the moisture content of dehydrated sludge discharged from a sludge dehydrator with a desired sludge moisture content (in other words, good moisture content for dehydrated sludge discharged from the sludge dehydrator) and sequentially displaying, by the display apparatus 41, facility operating procedures for making the moisture content of the dehydrated sludge approach the desired sludge moisture content, as a result of which it becomes possible to assist the operation of a facility for sewage sludge treatment.

Here, the moisture content of dehydrated sludge may be obtained using the calibration curve which is obtained as described above. For example, it may be that, using the calibration curve obtained as described above, the moisture content of dehydrated sludge discharged over time from a sludge dehydrator is calculated over time. In addition, the facility operating procedure described above can be made to be data indicating a procedure for operating a sludge dehydrator such that the moisture content of dehydrated sludge approaches a desired sludge moisture content. As an example, the facility operating procedure can be made to be data based on an operating procedure for a skilled worker. For example, it may be that the facility operating procedure includes an operating procedure for regulating the pressure of the sludge dehydrator such that the moisture content in dehydrated sludge approaches a desired sludge moisture content (an operating procedure for making the current moisture content approach the desired sludge moisture content by increasing dehydration pressure in a case where the current moisture content is greater than the desired sludge moisture content, and an operating procedure for making the current moisture content approach the desired sludge moisture content by lowering the dehydration pressure in a case where the current moisture content is less than the desired sludge moisture content).

Facility operating procedures and data pertaining to the desired sludge moisture content are stored in the storage resource in the computer 31. In addition, the storage resource in the computer 31 stores an operating procedure display program that is used to compare the desired sludge moisture content with the dehydrated sludge moisture content obtained while the sludge dehydrator is operating and sequentially display, on the display apparatus 41, facility operating procedures that are for the sludge dehydrator and are for making the moisture content of the dehydrated sludge be a good moisture content. The processor executes the operating procedure display program, as a result of which facility operating procedures for making the moisture content of the dehydrated sludge approach the desired sludge moisture content are sequentially displayed on the display apparatus 41, and it becomes possible to assist operation of a facility for sewage sludge treatment.

Next, a second embodiment is described. Note that, in the description of the present embodiment, there are cases where description that overlaps with details already described is omitted.

In the second embodiment, description is given regarding a sewage sludge treatment facility operation assistance navigation system that uses the calibration curve obtained in the first embodiment (in other words, using the calibration curve that is stored in S106 described above) to assist operation of a facility for sewage sludge treatment.

As an example, the sewage sludge treatment facility operation assistance navigation system is provided in order to realize control and operation assistance for a sewage treatment facility for improving the efficiency of sludge treatment at a sewage treatment plant at which sewage treatment facilities that are an agglomeration mixing tank, a sludge dehydrator, and a sludge storage tank are installed as a flow for sewage treatment steps. The agglomeration mixing tank is used in order to form agglomerated floc by adding a flocculant to cause suspended matter in sewage to agglomerate and achieve aggregated particles. Typically, an agitation apparatus is provided in the agglomeration mixing tank, and the inside of the agglomeration mixing tank is agitated by the agitation apparatus.

As an example, the sewage sludge treatment facility operation assistance navigation system is provided with an image capturing apparatus, an infrared measurement apparatus, an image-capturing signal processing apparatus, the infrared signal processing apparatus 22, the computer 31, and the display apparatus 41.

The image capturing apparatus has an image sensor, and converts an image of light (a physical quantity) from a target object into an electrical signal (may be referred to as an image signal) that correspond to the intensity of this light. As an example, the image capturing apparatus is provided such that it is possible to capture sludge inside the agglomeration mixing tank, and the image capturing apparatus outputs an image signal obtained by image capturing to the image-capturing signal processing apparatus. The image-capturing signal processing apparatus obtains image information by performing signal processing on the image signal inputted from the image capturing apparatus, and the obtained image information is outputted to the computer 31.

In the present embodiment, the storage resource in the computer 31 stores, as data, a desired agglomerated floc state, the desired sludge moisture content, and facility operating procedures. The desired agglomerated floc state is data indicating a good agglomerated floc state for the agglomeration mixing tank. The facility operating procedures include, as well as the sludge dehydrator operating procedure which is described in the first embodiment and is in order to make the sludge moisture content approach the desired sludge moisture content, an agglomeration mixing tank operating procedure in order for agglomerated floc in the agglomeration mixing tank to approach the desired agglomerated floc state.

Here, the facility operating procedure pertaining to the agglomeration mixing tank operating procedure can be made to be data based on an operating procedure by a skilled worker, as an example. The facility operating procedures may include an operating procedure for the agitation apparatus in the agglomeration mixing tank, in order for the agglomerated floc to approach desired agglomerated floc, for example. For example, there may be included an operating procedure for making agglomerated floc be smaller by increasing the speed of agitating the agglomeration mixing tank in a case where current agglomerated floc is larger than the desired agglomerated floc. The facility operating procedures may also include an operating procedure for adding a flocculant, in order for the agglomerated floc to approach desired agglomerated floc, for example. For example, there may be included an operating procedure for making agglomerated floc be larger by increasing the amount of flocculant added, in a case where current agglomerated floc is smaller than the desired agglomerated floc.

In the present embodiment, the operating procedure display program is used to compare the desired sludge moisture content with dehydrated sludge moisture content obtained while the sludge dehydrator is operating and sequentially display, on the display apparatus 41, facility operating procedures that are for the sludge dehydrator and are for making the dehydrated sludge moisture content be good moisture content, and also compare the desired agglomerated floc state with agglomerated floc obtained while the agglomeration mixing tank is operating and sequentially display, on the display apparatus 41, facility operating procedures that are for the agglomeration mixing tank and are for making the agglomerated floc state be a good state. The processor executes the operating procedure display program, as a result of which the facility operating procedures for the agglomeration mixing tank and the sludge dehydrator are sequentially displayed on the display apparatus 41, and it is possible to assist operation of facilities for sewage sludge treatment.

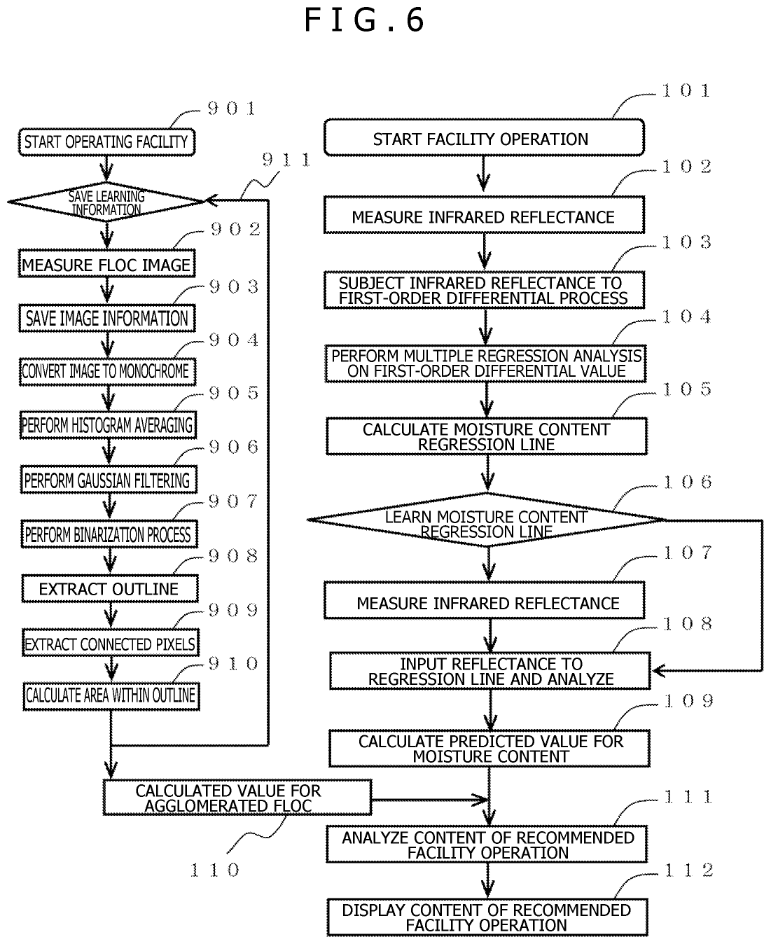

Next, description is given regarding an example of a processing flow for the sewage sludge treatment facility operation assistance navigation system. FIG. 6 is a flow chart for describing an example of processing by a sewage sludge treatment facility operation assistance navigation system. Note that, for description regarding S101 through S109 in FIG. 6, similar processing for the case of the first embodiment is performed, and this description is omitted.

After the sewage sludge treatment facility operation assistance navigation system starts operating (S901), processing for obtaining the desired agglomerated floc state is performed. Note that the processing step S901 can be at the same timing as that for the processing step S101.

After the start of operating, sludge inside the agglomeration mixing tank is measured over time by the image capturing apparatus, and image information is inputted to the computer 31 via the image-capturing signal processing apparatus (S902), and the image information is stored in the computer 31 (S903). Note that, it is sufficient if the computer 31 can obtain the image information, and operation by the image capturing apparatus may be controlled by the computer 31 as an example. In this case, the storage resource in the computer 31 stores a program for causing the image capturing apparatus to operate appropriately, and processor executes the program as a result of which the image capturing apparatus operates appropriately.

The computer 31 performs, on the obtained image information, image processing for clarifying agglomerated floc. The image processing is performed by the processor executing an appropriate program (in other words, an appropriate program for performing image processing) that is stored in the storage resource.

Description is given regarding the image processing (S904 through S910). Firstly, the computer 31 performs processing for converting the obtained image information to monochrome (S904). Next, processing for performing flattening (in other words, converting to higher contrast) is performed by performing histogram averaging processing on the monochrome image (S905). In the processing step S906, Gaussian filtering processing is performed on the image that has been subjected to the histogram averaging processing (in other words, processing for blurring the image and smoothly adjusting the luminance thereof is performed).

Next, the computer 31 performs binarization processing on the image that has been subjected to the Gaussian filtering processing (S907). As a result, a binary image for which a sewage region is set to a background portion is obtained. On this binary image, processing for extracting an outline of a pixel region in which a sewage portion is set to a background region is performed in order to analyze a portion of the agglomerated floc (S908). As a result, a portion for the agglomerated floc is extracted. Connectedness with the outline of the pixel region is determined, a portion that has the same value as pixels in the outline of the pixel region is extracted from the background portion, and a pixel connection region with respect to the background portion is extracted (S909).

Next, the pixel connection region is employed as the shape of the agglomerated floc, and processing for obtaining the number of accumulated pixels resulting from accumulating the number of pixels in the pixel connection region, and processing for calculating an agglomerated floc area which is the area of the agglomerated floc in accordance with converting the number of accumulated pixels on the basis of the area of pixels measured (obtained) by the image capturing apparatus. In other words, the number of pixels (number of accumulated pixels) in the pixel connection region is obtained, and the agglomerated floc area is converted from the number of accumulated pixels in consideration of the area of the image obtained by an image capturing apparatus 105 (S910).

Here, the above-described processing (S904 through S910) is, for example, performed by a skilled and experienced person having abundant experience in relation to operation of sewage sludge treatment facilities. A result (in other words, data regarding a good agglomerated floc state) based on operation of facilities by the skilled and experienced person is employed as the desired agglomerated floc state, and stored in (learned by) the storage resource in the computer 31 (S911). Note that the desired agglomerated floc state can be calculated as data regarding the area of the agglomerated floc, as an example.

In subsequent processing (in other words, after learning information is saved which is after S911), similar image processing is performed on image information that is regarding sludge and is obtained by the image capturing apparatus, and the agglomerated floc is calculated similarly to the case of the desired agglomerated floc state described above (S110).

By the processor executing the operating procedure display program, analysis processing for comparing the agglomerated floc (calculated in S110) with the desired agglomerated floc state and comparing the moisture content of dehydrated sludge (the prediction value outputted in S109) with the desired sludge moisture content is performed (S111). Agglomeration mixing tank operating procedures that are in order for the agglomeration mixing tank to approach the desired agglomerated floc state and sludge dehydrator operating procedures that are in order for the sludge dehydrator to approach the desired sludge moisture content are (in other words, details of recommended operations for facilities are) sequentially displayed on the display apparatus 41 (S112). According to the details displayed on the display apparatus 41, operation by workers of facilities for sewage sludge treatment is assisted.

By virtue of the present embodiment, it is possible to use the calibration curve described in the first embodiment to accurately calculate moisture content of dehydrated sludge, and cause a sewage sludge treatment facility operation assistance navigation system to operate. Note that, in the present embodiment, similarly to the case for the first embodiment, a calibration curve is obtained from dehydrated sludge having known moisture content, which is in the range of greater than or equal to 60 wt % and less than 90 wt %. In addition, using the calibration curve, measurement is performed for dehydrated sludge for which the moisture content is in a range of greater than or equal to 60 wt % and less than 85 wt %.

Next, a third embodiment is described. Note that, in the description of the present embodiment, there are cases where description that overlaps with details already described is omitted.

In the third embodiment, similarly to the case of the second embodiment, description is given regarding a sewage sludge treatment facility operation assistance navigation system that uses the calibration curve obtained in the first embodiment (in other words, using the calibration curve that has been stored in S106 described above) to assist operation of a facility for sewage sludge treatment.

In the present embodiment, as illustrated in FIG. 17, the absorbance of reflected infrared light is measured (S102′), the absorbance is subjected to offset correction (S103′), and a calibration curve is obtained from the data resulting from the offset correction. Analysis is performed by inputting the absorbance of reflected light to this calibration curve (S108′), as a result of which the moisture content is calculated. Note that, in the second embodiment, it is possible to use any of the moisture content measurement mechanism 2, the moisture content measurement mechanism 3, and the moisture content measurement mechanism 4, but the moisture content measurement mechanism 3 or the moisture content measurement mechanism 4 is used in the present embodiment. In addition, configuration is such that S102, S103, S107, and S108 are replaced by S102′, S103′, S107′, and S108′.

The present invention is not limited to the embodiments described above, and includes various variations. For example, the embodiments described above are described in detail for a better understanding of the present invention, and there is not necessarily a limitation to something provided with all of the configurations described.

In the embodiments described above, signal processing on obtained data is performed by the infrared signal processing apparatus 22, but, for example, it may be that the infrared signal processing apparatus 22 is configured as a portion of the computer 31, and the computer 31 performs signal processing on obtained data. In addition, it may be that the infrared signal processing apparatus 22 is omitted, the storage resource in the computer 31 is caused to store a program for performing the signal processing, and the processor executes this program whereby the signal processing is performed. In other words, the computer 31 may store, in the storage resource, data obtained by the measurement over time using the infrared measurement apparatus, and execute this program to calculate infrared reflectance and infrared absorbance from this data.

In the embodiments described above, signal processing on obtained data is performed by the image-capturing signal processing apparatus, but, for example, it may be that the image-capturing signal processing apparatus is configured as a portion of the computer 31, and the computer 31 performs signal processing on obtained data. In addition, it may be that the image-capturing signal processing apparatus is omitted, the storage resource in the computer 31 is caused to store a program for performing this signal processing, and the processor executes this program whereby the signal processing is performed. In other words, the computer 31 may store data obtained by measurement over time using the image capturing apparatus in the storage resource, and execute this program to obtain image information from this data.

The position of the image capturing apparatus described above is not particularly limited if it is possible to appropriately measure agglomerated floc in the agglomeration mixing tank. For example, the image capturing apparatus can be appropriately provided at a position where it is possible to measure agglomerated floc in the agglomeration mixing tank, such as inside the agglomeration mixing tank, outside of the agglomeration mixing tank, or at a sludge flow path on the downstream side of the agglomeration mixing tank.

A CPU can be considered as an example of the processor, but the processor may be another semiconductor device (for example, a GPU) in a case of being an agent that executes predetermined processing.

As an example, the storage resource can be considered to be a hard disk drive (HDD; Hard disk drive), but an appropriate recording apparatus can be employed for the storage resource. For example, the storage resource may be a solid-state drive (SSD; Solid State Drive), which is a drive that uses a semiconductor device memory.

It is considered that an obtained value for the reflectance or absorbance of infrared rays is impacted by temperature, humidity, the smoothness of the surface of the dehydrated sludge, and the distance between the dehydrated sludge and the light-receiving unit. Accordingly, an analytical process that considers a location for measuring sludge, the temperature or humidity in the vicinity thereof, the smoothness of the surface of the dehydrated sludge, and the distance between the dehydrated sludge and a light-receiving unit may be performed. In addition, a measured result may be corrected according to the temperature, humidity, the smoothness of the surface of the dehydrated sludge, and the distance between the dehydrated sludge and the light-receiving unit. As a result, improving measurement accuracy can be addressed.

Description is given regarding a comparative example. Similarly to the first embodiment, the infrared reflectance for dehydrated sludge is measured, a calibration curve is obtained by executing multivariate regression analysis without performing first-order differential processing and, a result of calculating moisture content predicted from a measurement value from the infrared reflectance of dehydrated sludge using this calibration curve is that a determined coefficient (R2) is 0.686 and prediction variation (standard deviation) is 4.756 wt %, having lower and insufficient measurement accuracy in comparison to the first embodiment. Note that measurement is performed using the same configuration as the infrared measurement apparatus 21.

### REFERENCE SIGNS LIST

1: Moisture content measurement system
2: Moisture content measurement mechanism
3: Moisture content measurement mechanism
4: Moisture content measurement mechanism
11: Sludge dehydrator dehydration unit
12: Sludge dehydrator discharge unit
21: Infrared measurement apparatus
21a: Infrared measurement apparatus
21b: Infrared measurement apparatus
22: Infrared signal processing apparatus
31: Computer
41: Display apparatus

1. An electronic computer capable of calculating moisture content of dehydrated sludge discharged from a sludge dehydrator belonging to a sewage treatment plant, the electronic computer comprising:
a processor; and a storage resource, wherein
a moisture content calculation program is disposed in the storage resource, and
the processor
executes the moisture content calculation program, and
calculates moisture content of dehydrated sludge using a calibration curve for calculating the moisture content of the dehydrated sludge, the calibration curve being obtained by performing multivariate regression analysis after differential processing or offset correction on absorbance for reflected light or reflectance for infrared rays from dehydrated sludge, the absorbance or the reflectance being obtained by measuring the dehydrated sludge using an infrared measurement apparatus provided with a light-receiving unit that can receive at least infrared rays reflected from a target object to be measured and a light source that has a plurality of infrared LEDs that can emit infrared rays having respectively different wavelengths or a light source having a lamp that can continuously emit infrared rays.

2. The electronic computer according to claim 1, wherein
the calibration curve is obtained from dehydrated sludge having moisture content in a range of greater than or equal to 60 wt % and less than 90 wt %, and
moisture content of dehydrated sludge calculated using the calibration curve is in a range of greater than or equal to 60 wt % and less than 85 wt %.

3. The electronic computer according to claim 1, wherein
the calibration curve is obtained using absorbance for reflected light or reflectance for infrared rays, the absorbance or the reflectance being obtained by causing emission of infrared rays having a wavelength range of 1100 to 2400 nm.

4. The electronic computer according to claim 1, wherein
the storage resource
stores as data therein
a desired agglomerated floc state being a good agglomerated floc state for an agglomeration mixing tank at a sewage treatment plant,
a desired sludge moisture content being good moisture content for dehydrated sludge discharged from a sludge dehydrator, and
facility operating procedures that are for the agglomeration mixing tank and the sludge dehydrator and are for setting an agglomerated floc state for the agglomeration mixing tank to the desired agglomerated floc state and for making moisture content of dehydrated sludge discharged from the sludge dehydrator be the desired sludge moisture content,
stores therein an operating procedure display program used to compare the desired agglomerated floc state and the desired sludge moisture content with the agglomerated floc state obtained while a sewage treatment facility is operating and the moisture content that is for the dehydrated sludge and is obtained while the sewage treatment facility is operating, and used to sequentially display, on a display apparatus, the facility operating procedures that are for the agglomeration mixing tank and the sludge dehydrator and are for making the agglomerated floc state be a good state and making the moisture content of the dehydrated sludge be good moisture content, and
when the processor executes the operating procedure display program and
executes processing for comparing the desired agglomerated floc state and the desired sludge moisture content with the agglomerated floc state obtained while the sewage treatment facility is operating and the moisture content that is for the dehydrated sludge and is obtained while the sewage treatment facility is operating, and for sequentially displaying, on a display apparatus, facility operating procedures that are for the agglomeration mixing tank and the sludge dehydrator and are for making the agglomerated floc state be a good state and making the moisture content of the dehydrated sludge be good moisture content,
the processor executes the moisture content calculation program, and
uses the calibration curve to calculate moisture content of dehydrated sludge discharged from the sludge dehydrator.

5. The electronic computer according to claim 1, wherein
first-order differential processing or offset correction processing is performed before the multivariate regression analysis.

6. A moisture content measurement method for calculating moisture content of dehydrated sludge using an electronic computer, the method comprising:
calculating moisture content of dehydrated sludge by using a calibration curve for calculating the moisture content of the dehydrated sludge, the calibration curve being obtained by performing multivariate regression analysis after differential processing or offset correction processing is performed on absorbance for reflected light or reflectance for infrared rays from dehydrated sludge, the absorbance or the reflectance being obtained by measuring the dehydrated sludge using an infrared measurement apparatus provided with a light-receiving unit that can receive at least infrared rays reflected from a target object to be measured and a light source that has a plurality of infrared LEDs that can emit infrared rays having respectively different wavelengths or a light source having a lamp that can continuously emit infrared rays.

7. The moisture content measurement method according to claim 6, wherein
the calibration curve is obtained from dehydrated sludge having moisture content in a range of greater than or equal to 60 wt % and less than 90 wt %, and
moisture content of dehydrated sludge calculated using the calibration curve is in a range of greater than or equal to 60 wt % and less than 85 wt %.

8. The moisture content measurement method according to claim 6, wherein
the calibration curve is obtained using absorbance for reflected light or reflectance for infrared rays, the absorbance or the reflectance being obtained by causing emission of infrared rays having a wavelength range of 1100 to 2400 nm.

9. The moisture content measurement method according to claim 6, wherein
the calibration curve is used to calculate moisture content of dehydrated sludge discharged from the sludge dehydrator during operation of a sewage sludge treatment facility operation assistance navigation system that performs assistance for making moisture content of dehydrated sludge discharged from the sludge dehydrator approach good moisture content.

10. The moisture content measurement method according to claim 6, wherein
first-order differential processing or an offset correction is performed before the multivariate regression analysis.

11. A program for causing an electronic computer to execute the moisture content measurement method according to claim 6.

12. A moisture content measurement system, comprising:
a processor; a storage resource; a sludge dehydrator; and an infrared measurement apparatus, wherein
the sludge dehydrator
is installed at a sewage treatment plant, dehydrates sludge, and discharges dehydrated sludge, and
the infrared measurement apparatus
is provided with a light-receiving unit that can receive at least infrared rays reflected from a target object to be measured and a light source that has a plurality of infrared LEDs that can emit infrared rays having respectively different wavelengths or a light source having a lamp that can continuously emit infrared rays
a moisture content calculation program is disposed in the storage resource, and
the processor
executes the moisture content calculation program, and
calculates moisture content of dehydrated sludge using a calibration curve for calculating the moisture content of the dehydrated sludge, the calibration curve being obtained by performing multivariate regression analysis after differential processing or offset correction processing is performed on absorbance for reflected light or reflectance for infrared rays from dehydrated sludge, the absorbance or the reflectance being obtained by measuring the dehydrated sludge using the infrared measurement apparatus.

13. The moisture content measurement system according to claim 12, wherein
the calibration curve is obtained from dehydrated sludge having moisture content in a range of greater than or equal to 60 wt % and less than 90 wt %, and
moisture content of dehydrated sludge calculated using the calibration curve is in a range of greater than or equal to 60 wt % and less than 85 wt %.

14. The moisture content measurement system according to claim 12, wherein
the calibration curve is obtained using absorbance for reflected light or reflectance for infrared rays, the absorbance or the reflectance being obtained by causing emission of infrared rays having a wavelength range of 1100 to 2400 nm.

15. The moisture content measurement system according to claim 12, wherein
first-order differential processing or an offset correction is performed before the multivariate regression analysis.
